(19) United States
(12) Patent Application Publication
(10) Pub. No.: US 2005/0251446 A1
(43) Pub. Date: Nov. 10, 2005

(54) Methods and systems for integration of multiple rewards programs

(76) Inventors: Wei Jiang, Forest Hills, NY (US); Declan Collins, New York, NY (US); Liesl Leach, New York, NY (US)

Correspondence Address: KILPATRICK STOCKTON LLP, 607 14TH STREET, N.W., WASHINGTON, DC, 20005, US

(21) Appl. No.: 11/090,677

(22) Filed: Mar. 25, 2005

Related U.S. Application Data
(60) Provisional application No. 60/556,610, filed on Mar. 26, 2004.

(51) Int. Cl. G06F 17/60; G06K 5/00

(52) U.S. Cl. 705/14; 235/380

(57) ABSTRACT

A method and system for consolidating loyalty rewards from multiple programs into a single currency which is managed in a single account allows a customer to utilize accumulated rewards for making full or partial payments at a point of sale with an online merchant. A payment transaction can represent the use of multiple accounts (i.e., reward currency, credit card, or debit card). When executing the transaction, the system conceals a customer's account information by generating a virtual account number (VAN). As such, the online merchant is not required to have any prior knowledge of the system and processes the transaction as a conventional credit card purchase.

### PRIORITY APPLICATIONS

This application claims priority to co-pending U.S. Provisional Application No. 60/556,610, filed Mar. 26, 2004, entitled “METHODS AND SYSTEMS FOR INTEGRATION OF MULTIPLE REWARDS PROGRAMS”, which is incorporated herein by this reference.

### FIELD OF THE INVENTION

The present invention relates generally to the field of electronic commerce, and more particularly to methods and systems for integration of multiple loyalty or rewards programs.

### BACKGROUND OF THE INVENTION

Currently there are myriads of different loyalty or rewards points programs in existence in which card members, for example, earn some type of currency, such as points, miles or the like. Generally speaking, however, each such program has its own loyalty vehicle for redemption of rewards, and it is not typically feasible for card members of different loyalty programs to access the same loyalty vehicle for redemption of rewards. There is a present need for a capability that allows card members, for example, to redeem loyalty or rewards points from different loyalty or rewards points programs via a single loyalty redemption vehicle.

### SUMMARY OF THE INVENTION

It is a feature and advantage of the present invention to provide a method and system for loyalty or rewards program integration that affords a capability to collapse multiple different loyalty or rewards programs into a single rewards currency.

It is a further feature and advantage of the present invention to provide a method and system for loyalty or rewards program integration that make rewards points extremely easy to redeem by providing a broad and deep set of merchandise or inventory for card members.

It is another feature and advantage of the present invention to provide a method and system for loyalty or rewards program integration that provides a rewards currency which card members can use directly at the point of sale, either offline or online, for example, at an online merchant.

It is an additional feature and advantage of the present invention to provide a method and system for loyalty or rewards program integration that provides a rewards currency which card members can use in an online merchant transaction as if it were cash without requiring the online merchant to make any changes to its internal systems to be able to accept the rewards program currency at the point of sale.

It is a still further feature and advantage of the present invention to provide a method and system for loyalty or rewards program integration that provides a rewards currency which card members can use in an online merchant transaction which can then be processed by the merchant as if it were a normal credit card transaction without the merchant having to perform any technical integration.

To achieve the stated and other features, advantages and objects, an embodiment of the present invention provides a method and system for loyalty or rewards program integration that collapses a multitude of different loyalty or rewards programs, in which card members earn some type of currency, such as rewards points, into essentially a single currency, so that card members are allowed, for example, to tell a financial institution, such as a bank, if they want a purchase to come out of their rewards account, a combination of their rewards account and their credit card account, or completely out of their credit card account. The transaction is then processed by the merchant as if it were a normal credit card transaction without requiring the merchant to perform any technical integration whatsoever.

In particular, an embodiment of the invention utilizes computer hardware and software to provide a method and system of using rewards currency units directly at a point of sale in which a card member at a computing device is allowed to enter a selection of an option for a method of payment for a transaction with a merchant and a selection to generate a virtual account number. The payment method options consist at least in part of payment of a purchase amount wholly with single currency reward units or payment of a portion of the purchase amount with single currency reward units and a balance of the purchase amount with a credit charge. The card member is allowed to enter the selections via a virtual account number application pre-installed on the computing device that auto-pops when a credit card account number field at a checkout page of the merchant's website is detected by the virtual account number application.

In an embodiment of the invention, when the virtual account number application auto-pops, an artificial intelligence function of the virtual account number application determines whether a credit card account of the card member qualifies for a single currency rewards program and whether the merchant's website qualifies for the single currency rewards program. If so, a payment screen is displayed for the card member prompting entry of the selection of the option for the method of payment and the selection to generate the virtual account number. In addition, a cash value of a balance of currency rewards units available to the card member for redemption at the merchant website, adjusted according to a redemption rate associated with the merchant, is displayed for the card member on the payment screen.

Upon receiving entry of the card member's selections, according to an embodiment of the invention, a log is created for the virtual account number with information consisting at least in part of the purchase amount and the selected payment method by a virtual account number engine, which also accesses a single currency rewards database to determine whether the card member has a sufficient balance of single currency rewards units for the payment of the purchase amount according to the selected payment method. If so, the virtual account number engine generates and presents a virtual account number for use by the card member in the transaction with the merchant. If not, the card member is prompted to re-specify the card member's selection of payment method and the virtual account number is closed by the virtual account number engine. Otherwise, the card member is allowed to present the virtual account number to the merchant for payment of the purchase amount as if it were an actual credit card number.

Upon receiving the virtual account number, in an embodiment of the invention, the merchant submits a request for authorization of the transaction with the virtual account number, for example, to a card-issuing financial institution. Upon receipt of the request for authorization, the request is checked, for example, by the financial institution against the log for the virtual account number to determine an amount of credit charge necessary to pay the purchase amount net of any portion of the purchase amount to be paid by single currency reward units. In addition, any credit charge portion of the request for authorization through a virtual account number authorization processor, and an authorization for the transaction is sent to the merchant, for example, by the financial institution.

Thereafter, according to an embodiment of the invention, a request for settlement of the transaction is received from the merchant according to the authorization, for example, by the financial institution. Upon receiving the settlement request, the card member's single currency reward account is decremented by an amount equal to any portion of the purchase amount to be paid with single currency reward units in response to a communication of the amount of the portion of the purchase amount to be paid with single currency reward units to the single currency rewards database. Additionally, an amount of a credit charge necessary to pay the purchase amount net of any portion of the purchase price paid by single currency reward units is processed through a credit card settlement system.

Additional objects, advantages and novel features of the invention will be set forth in part in the description which follows, and in part will become more apparent to those skilled in the art upon examination of the following, or may be learned from practice of the invention.

### BRIEF DESCRIPTION OF THE DRAWINGS

FIG. 1 is a flow diagram that illustrates an example of the process of serving an appropriate sign-in page (i.e., qualifying for the single currency rewards program) for an embodiment of the invention;

FIG. 2 shows an example of a regular virtual account number GUI screen displayed for card members who do not qualify for the single currency rewards program for an embodiment of the invention;

FIG. 3 shows an example of a virtual account number GUI screen with a single currency rewards program capability displayed for card members who qualify for the single currency rewards program for an embodiment of the invention;

FIG. 4 is a flow chart which illustrates an example of the process of creating a virtual account number for an embodiment of the invention;

FIG. 5 is a flow chart that illustrates an example of the process of authorization of the virtual account number and settlement of a transaction for an embodiment of the invention;

FIG. 6 is a flow chart that illustrates an example of the process of return for full refund (i.e., no deduction of shipping, restocking, or the like) for an embodiment of the invention; and

FIG. 7 is a flow chart that illustrates an example of the process of return for partial refund (i.e., refund for part of the merchandise or service less deduction of shipping charges, re-stocking fees, and the like) for an embodiment of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

An aspect of the present invention involves a method and system for loyalty or rewards program integration that provides a platform to enable collapsing a multitude of different loyalty or rewards programs in which card members earn some type of currency, such as rewards points, miles and the like, into essentially a single currency, so that multiple cards can access the same loyalty vehicle. In this regard, a key objective of the present invention is to make rewards extremely easy to redeem, which is accomplished, for example, by creating essentially a set of merchandise or inventory that is extremely broad and deep, so that customers perceive they have essentially the world at their fingertips and can use the rewards currency provided by an embodiment of the invention anywhere they can use their cards.

An overview example of key components of the system for an embodiment of the invention from a user's perspective includes, for example, a card member's PC or desktop computer communicating over a network, such as the Internet, with a merchant server from a shopping perspective, and also with a financial institution server, for example, from the virtual account number aspect. From the user's perspective, for example, there are two sessions open, one to the merchant's web server and one to the financial institution's web server. Other overview examples of key components of the system for an embodiment of the invention include multiple intermediaries within the whole transaction, including for example communications between the merchant, the financial institution, and a credit card network.

An aspect of the invention is to allow customers to use the rewards currency that is provided by the present invention directly at the point of sale, either offline or online, for example, at an online merchant. An embodiment of the invention enables card members of such a rewards program to use their awards points directly, as if the points were cash, at the point of sale with the online merchant without requiring the online merchant to make any changes to its internal systems to be able to accept the rewards program currency at the point of sale. The method and system of the present invention allows the card members themselves to tell, for example, a financial institution, such as a bank, whether or not they want the purchase to come out of their rewards account, a combination of their rewards account and their credit card account, or totally out of their credit card account. The transaction is then processed by the merchant as if it were a normal credit card transaction without the merchant having to do any technical integration whatsoever.

In a “backend” aspect of an embodiment of the invention, when the transaction information is received by the financial institution, it is split into its appropriate parts. The financial institution determines whether the card member has enough rewards currency and/or available credit limit to complete the purchase, and sends an authorization back to the merchant. The merchant has enough knowledge at this point, regardless of whether the transaction is simply a regular credit card transaction or a transaction involving payment via a rewards account or via a combination of credit and rewards account, and the transaction is completed. Thus, an embodiment of the invention allows card members to use rewards points as a non-cash currency as if it were cash at the point of sale with an online merchant. While the present discussion focuses on an online merchant aspect of the method and system for an embodiment of the invention, it will be appreciated by those of ordinary skill in the art that the same essential backend switching mechanism can also be utilized, for example, in transactions with offline merchants as well.

An embodiment of the invention makes use of virtual account numbers as described, for example, in U.S. Pat. No. 6,636,833 entitled “Credit Card System and Method”, incorporated herein by this reference, wherein a virtual credit card number that appears and functions as a normal credit card number is generated by a software application for use in an online purchase transaction that does not require online merchants to have any special processing technology or to even be aware of the virtual nature of the credit card number. Prior to arriving at a sign-in page, a customer is required to download the virtual account number software for an embodiment of the invention onto the card member's computing device, such as a personal computer (PC), or to log-in and launch a virtual account number application from a website. In order to download the virtual account number software, the card member logs in, for example, to a financial institution website and authenticates himself or herself into the financial institution's system. The card member is then allowed to enroll in the virtual account number service and download the software application onto his or her PC.

Thereafter, the download version of the virtual account number software for an embodiment of the invention actually auto-pops at the checkout screens of online merchants. The virtual account number software basically detects the credit card number field when a checkout page requests a credit card number and therefore auto-pops. When the virtual account number software auto-pops, an artificial intelligence function of the invention determines whether the card member's card account qualifies for the single currency rewards program of the invention, and if so, whether the particular online merchant's website qualifies for the single currency rewards program. If the answer to either determination is “no”, the card member is presented a regular virtual account number sign-in screen, but if the answer to both determinations is “yes”, the card member is presented a multi-function sign-in screen for an embodiment of the invention.

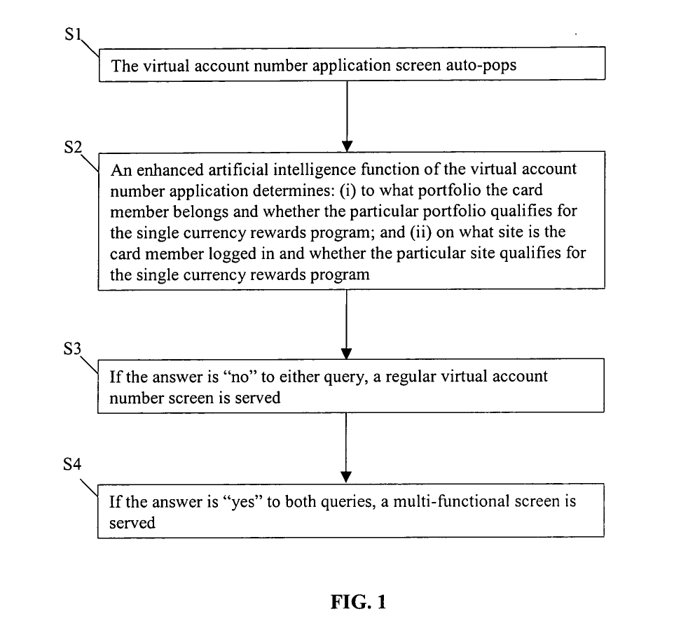

FIG. 1 is a flow diagram that illustrates an example of the process of serving an appropriate sign-in page (i.e., qualifying for the single currency rewards program) for an embodiment of the invention. Referring to FIG. 1, at S1 the virtual account number application screen auto-pops, and at S2, an enhanced artificial intelligence function of the virtual account number application determines: (i) to what portfolio the card member belongs and whether the particular portfolio qualifies for the single currency rewards program; and (ii) on what site is the card member logged in and whether the particular site qualifies for the single currency rewards program. At S3, if the answer is “no” to either query, a regular virtual account number screen is served, but at S4, if the answer is “yes” to both queries, a multi-functional screen is served.

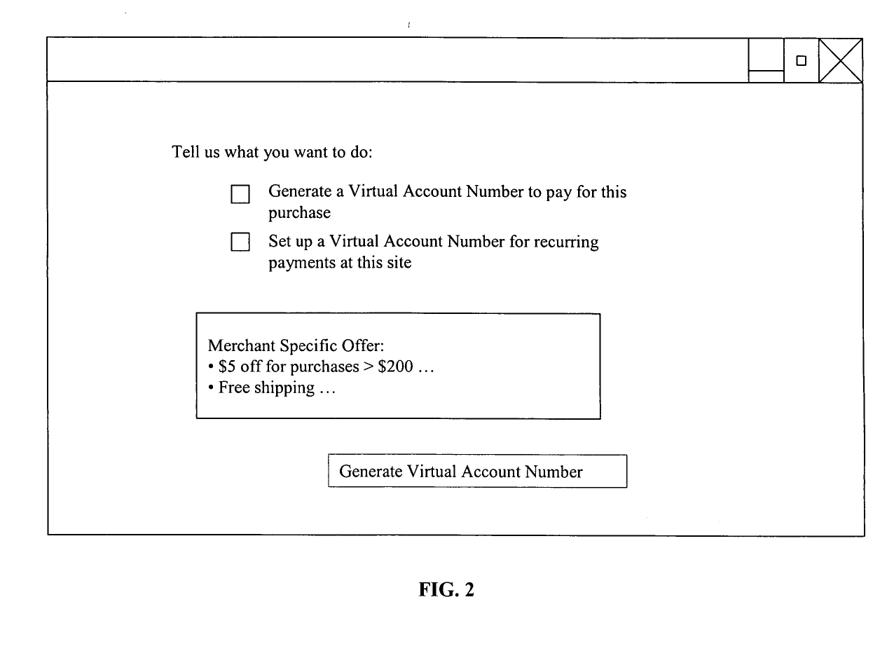

FIG. 2 shows an example of a regular virtual account number GUI screen displayed for card members who do not qualify for the single currency rewards program for an embodiment of the invention. Referring to FIG. 2, card members who do not qualify for the single currency rewards program are prompted for selection of options to generate a virtual account number to pay for the purchase and to set up a virtual account number for recurring payments at the particular web site.

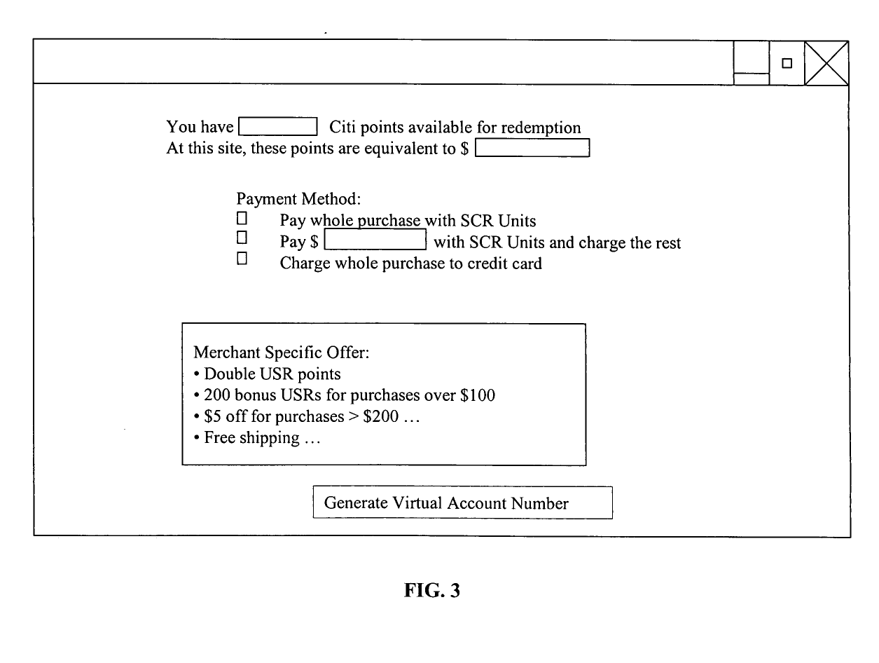

FIG. 3 shows an example of a virtual account number GUI screen with a single currency rewards program capability displayed for card members who qualify for the single currency rewards program for an embodiment of the invention. Referring to FIG. 3, card members who qualify for the single currency rewards program are prompted for selection of a payment method. If a card member selects a payment method option to charge the entire purchase price to a credit card, the user experience is the same as for card members who do not qualify for the single currency rewards program.

On the other hand, card members who select a payment option either to pay the purchase with single currency rewards units or to pay a specified portion of the purchase price with single currency rewards units and charge the rest to a credit card proceed through a process of creating a virtual account number. In either case, the card member is prompted to enter a user name and password, which is required because it is a secured system that requires the card member to authenticate into the system. Likewise, in either case, the card member can also be presented with merchant specific offers through the interface. In alternative embodiments, the card member is presented the multi-function sign-in screen for an embodiment of the invention whether or not the particular online merchant's website qualifies for the single currency rewards program.

Once the card member enters a user name and password and is authenticated into the system, if the artificial intelligence function determines that either or both of the card member's card account and the particular online merchant's website does not qualify for the single currency rewards program, the card member is presented the standard virtual account number payment tool GUI screen shown in FIG. 2 without single currency rewards functionality, which centrally focuses only on the virtual account number functionality. Thus, the regular virtual account number sign-in GUI screen shown in FIG. 2 prompts the card member with options to generate a virtual account number to pay for his or her purchase or to set up a virtual account number at the particular website. For example, if the card member anticipates recurring payments, he or she may wish to use a specific virtual account number multiple times. At that point, the card member designates which one of those options he or she wants and clicks on a selection to generate a virtual account number.

If, on the other hand, the artificial intelligence function determines that both the card member's card account and the particular online merchant's website qualify for the single currency rewards program, the card member is presented the single currency rewards payment tool interface shown in FIG. 3. A functionality of the single currency rewards system of the invention pulls the card member's rewards points balance that is available for redemption from the financial institution's rewards system and displays it for the card member. A further functionality of the system also communicates a cash value of what those rewards points are worth at the particular online merchant for the card member. In the background, the single currency rewards system of an embodiment of the present invention also addresses issues, such as different exchange rates at different merchants, resulting in the possibility of differing cash values from merchant to merchant.

The card member is prompted to select one of several payment methods on the single currency rewards payment tool interface shown in FIG. 3 by which to pay for the purchase. The payment methods include, for example, payment of the entire purchase price with single currency reward points or units, payment in part with single currency reward points or units and in part with a credit card charge, or payment entirely with a credit card charge. At that point, the card member enters a selection for the method of payment and likewise clicks on a selection to generate a virtual account number.

When the card member clicks on a selection to generate a virtual account number for an embodiment of the invention, on the backend, a virtual account number engine collects and aggregates a substantial amount of information in addition to the card member's selection, and specifies and sends that information back to a virtual account number server. Once the card member enters his or her selection of the payment method, the choice is recorded as the card member's choice of a “payment split”. If reward points are involved in the payment split, the appropriate rewards balance is deducted, so that the card member does not “double dip”. At that point, the virtual account number engine generates a virtual account number and, behind the scenes, information is recorded with the virtual account number as to how the payment amount will be effected on the backend. In addition, if there are specific merchant-related offers of which the card member wants to take advantage, the virtual account number engine takes that information as well.

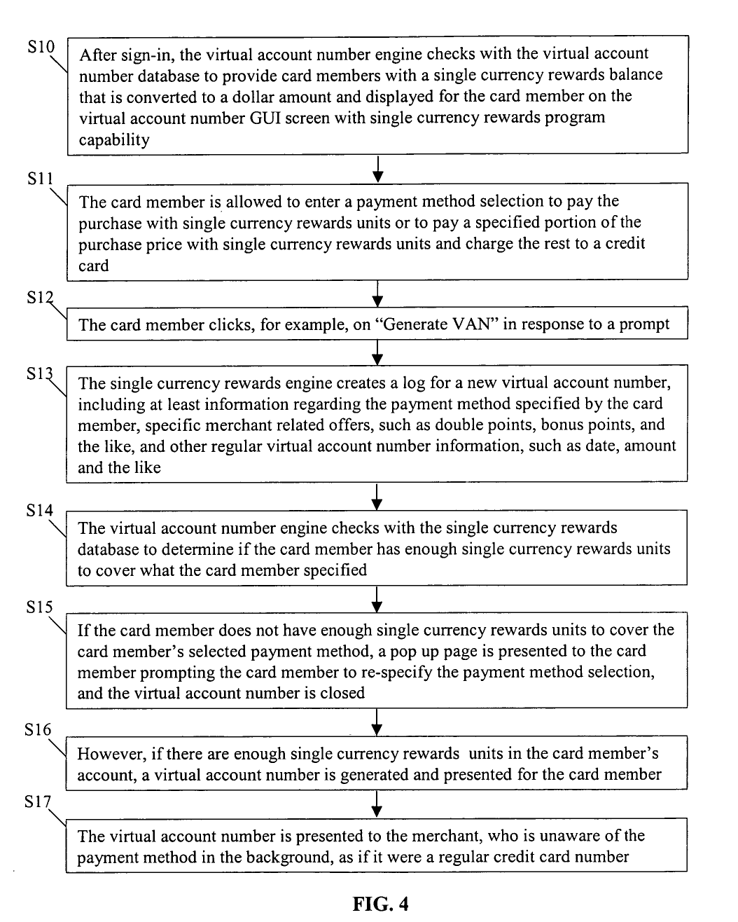

FIG. 4 is a flow chart which illustrates an example of the process of creating a virtual account number for an embodiment of the invention. Referring to FIG. 4, at S10, after sign-in, the virtual account number engine checks with the virtual account number database to provide card members with a single currency rewards balance that is converted to a dollar amount and displayed for the card member on the virtual account number GUI screen with single currency rewards program capability shown in FIG. 3. At S11, the card member is allowed to enter a payment method selection to pay the purchase price with single currency rewards units or to pay a specified portion of the purchase price with single currency rewards units and charge the rest to a credit card. At S12, when the card member clicks, for example, on “generate virtual account number” in response to a prompt, at S13, the virtual account number engine creates a log for a new virtual account number, including at least information regarding the payment method specified by the card member, specific merchant related offers, such as double points, bonus points, and the like, and other regular virtual account number information, such as date, amount, and the like.

Referring further to FIG. 4, at S14, the virtual account number engine checks with the single currency rewards database to determine if the card member has enough single currency rewards units to cover what the card member specified. At S15, if the card member does not have enough single currency rewards units to cover the card member's selected payment method, a pop up page is presented to the card member prompting the card member to re-specify the payment method selection, and the virtual account number is closed. However, at S16, if there are enough single currency rewards units in the card member's account, a virtual account number is generated and presented for the card member. At S17, the virtual account number is presented to the merchant, who is unaware of the payment method in the background, as if it were a regular credit card number.

In the backend, prior to entry of the card member's choice of a payment split, the virtual account number engine queries the single currency rewards database to determine whether or not the card member has sufficient rewards points to cover the purchase. That information is presented to the card member in order for the card member to make the choice of a payment split. Upon entry of the card member's selection of a payment split, the appropriate points balance is deducted, and at that point, the card member can enter a selection to generate the virtual account number. In other words, the rewards points database is searched, and the card member's choices of a payment split are based on the card member's rewards points balance. If the card member's balance is insufficient, the card member's choices for a payment split are limited.

There are a number of conditions that must be met in order for a card member to utilize the single rewards currency for an embodiment of the invention. For example, the card member must be the holder of a card issued by the financial institution that qualifies for a virtual account number. Secondly, at the very least the card member must have undertaken to enroll in the virtual account number service. Third, the card member must have downloaded the virtual account number software onto his or her PC, for example, at home, at work, or both. Having met those conditions, the card member can then authenticate into the system with a single and unique user name and password combination.

In an embodiment of the invention, the merchant sends in the virtual account number information for authorization in exactly the same way it would send in any other credit card number, and the authorization request is checked against the virtual account number log to see how much credit is needed for the transaction. When the authorization request is received by the financial institution, the virtual account number is converted to a physical number for the card member, and a business-as-usual credit check is performed back in the financial institution for a credit decision for any credit portion of the authorization request. Once the credit decision is returned, the financial institution responds to the merchant with an authorization number in the same way as with any credit card charge.

After the merchant receives the requested authorization, the merchant begins its normal settlement process as in any credit card transaction and sends in the authorized transaction for settlement, for example, via the MASTERCARD or VISA card network. When the authorized transaction is received by the financial institution, it is checked against the financial institution's virtual account number log that has previously recorded the authorization for the transaction to separate the total amount of the transaction into the portion to be covered by single currency rewards points or units and therefore deducted from the card member's rewards account, and the portion that should be split off to the credit system and charged against the card member's credit limit. The credit portion of the purchase that actually goes against the card member's credit limit then goes through the existing credit card settlement process as normal.

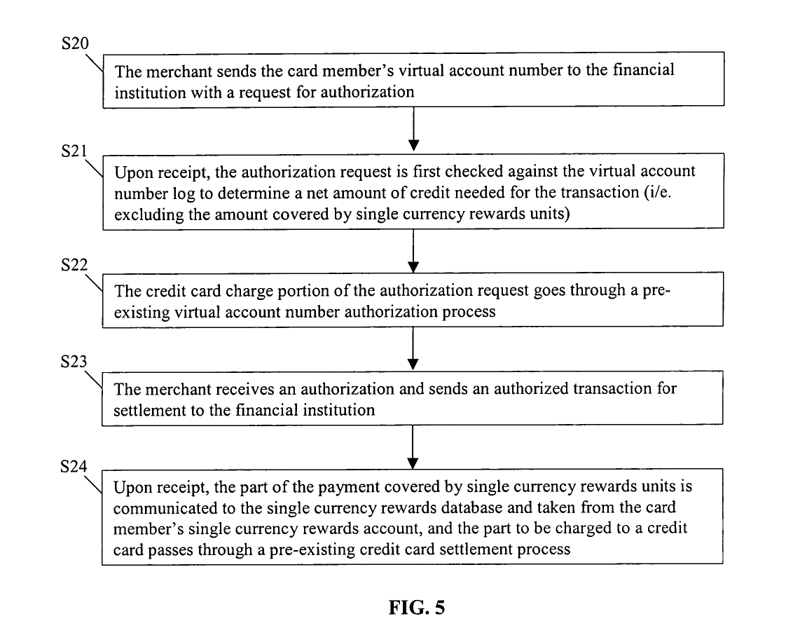

FIG. 5 is a flow chart that illustrates an example of the process of authorization of the virtual account number and settlement of a transaction for an embodiment of the invention. Referring to FIG. 5, at S20, the merchant sends the card member's virtual account number to the financial institution with a request for authorization. At S21, upon receipt, the authorization request is first checked against the virtual account number log to determine a net amount of credit needed for the transaction (i.e. excluding the amount covered by single currency rewards units). Thereafter, at S22, the credit card charge portion of the authorization request goes though a pre-existing virtual account number authorization process. Referring further to FIG. 5, at S23, the merchant receives an authorization and sends an authorized transaction for settlement to the financial institution. At S24, upon receipt, the part of the payment covered by single currency rewards units is communicated to the single currency rewards database and taken from the card member's single currency rewards account, and the part to be charged to a credit card passes through a pre-existing credit card settlement process.

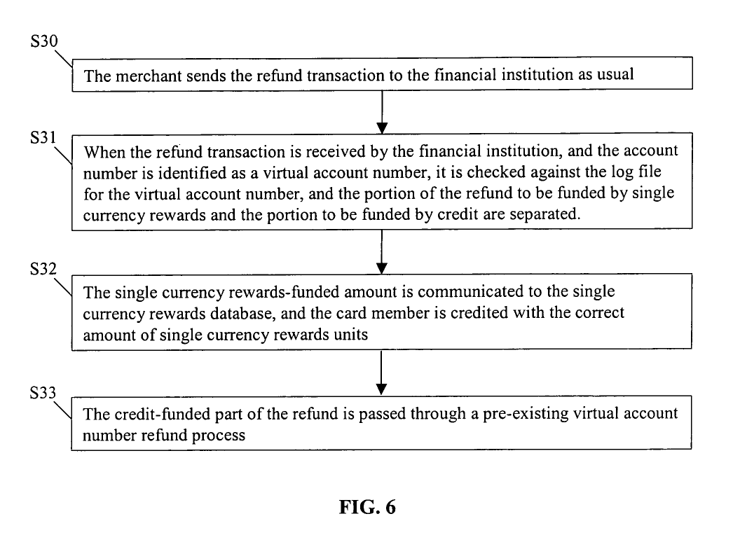

FIG. 6 is a flow chart that illustrates an example of the process of return for full refund (i.e., no deduction of shipping, restocking, or the like) for an embodiment of the invention. Referring to FIG. 6, at S30, the merchant sends the refund transaction to the financial institution as usual. At S31, when the refund transaction is received by the financial institution, and the account number is identified as a virtual account number, it is checked against the log file for the virtual account number, and the portion of the refund to be funded by single currency rewards and the portion to be funded by credit are separated. At S32, the single currency rewards-funded amount is communicated to the single currency rewards database, and the card member is credited with the correct amount of single currency rewards units. At S34, the credit-funded part of the refund is passed through a pre-existing virtual account number refund process. Thus, if a card member returns merchandise for a full refund, the merchant makes a refund, including shipping, to the card member. The return is then passed to the financial institution where it is balanced against the log that was created for the particular virtual account number, and the total amount is separated into rewards points and cash credit. The cash credit is applied to the card member's credit card account and will appear on his or her credit card statement, and the rewards points or units will be applied to the card member's rewards point total.

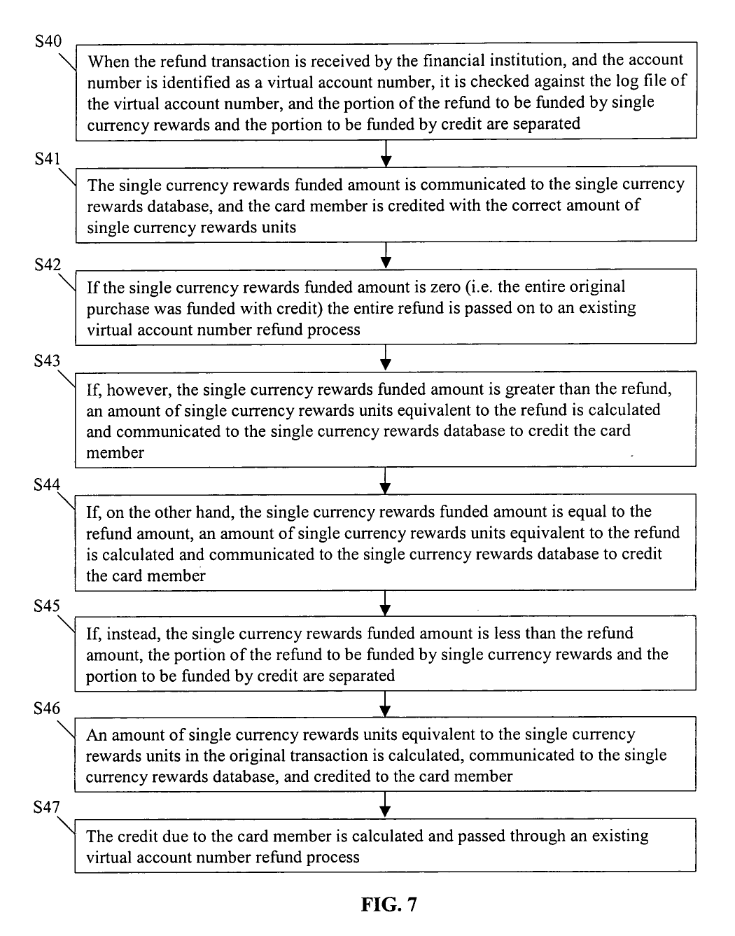

FIG. 7 is a flow chart that illustrates an example of the process of return for partial refund (i.e., refund for part of the merchandise or service less deduction of shipping charges, re-stocking fees, and the like) for an embodiment of the invention. Referring to FIG. 7, at S40, when the refund transaction is received by the financial institution, and the account number is identified as a virtual account number, it is checked against the log file of the virtual account number, and the portion of the refund to be funded by single currency rewards and the portion to be funded by credit are separated. At S41, the single currency rewards funded amount is communicated to the single currency rewards database, and the card member is credited with the correct amount of single currency rewards units. At S42, if the single currency rewards funded amount is zero (i.e. the entire original purchase was funded with credit) the entire refund is passed to an existing virtual account number refund process. At S43, if however, the single currency rewards funded amount is greater than the refund, an amount of single currency rewards units equivalent to the refund is calculated and communicated to the single currency rewards database to credit the card member. At S44, if on the other hand, the single currency rewards funded amount is equal to the refund amount, an amount of single currency rewards units equivalent to the refund is calculated and communicated to the single currency rewards database to credit the card member.

Referring further to FIG. 7, at S45, if instead, the single currency rewards funded amount is less than the refund amount, the portion of the refund to be funded by single currency rewards and the portion to be funded by credit are separated, and at S46, an amount of single currency rewards units equivalent to the single currency rewards units in the original transaction is calculated, communicated to the single currency rewards database, and credited to the card member. At S47, the credit due to the card member is calculated and passed through an existing virtual account number refund process. Thus, in the event of a partial refund in which, for example, the merchant deducts shipping costs and/or a restocking fee, the financial institution refunds the rewards points first, and the balance is refunded in the form of credit applied to the card member's credit card account. If a partial refund is received by the financial institution, the amount is again separated into rewards points and cash credit using the virtual account log that was created when the virtual account number was generated. The rewards points are refunded first, and if that satisfies the entire amount of the refund, no cash credit is applied to the card member's credit card account. However, if not, the balance is applied to the card member's credit card account as a cash credit, which will likewise appear on the card member's credit card statement. In alternative embodiments, in the event of a partial refund, a pro-rated amount that pertains to the original share of the original transaction that consisted of rewards points (versus cash) is refunded to the appropriate account.

An alternative embodiment of the present invention, which likewise employs the concept of payment using a rewards currency at the merchant website, simplifies a payment transaction, for example, by processing the transaction for the full dollar amount of the purchase and applying a statement credit for the rewards portion. In a purchase aspect of the alternative embodiment, once the credit/available rewards split has been determined, the single currency rewards system issues a rewards authorization on the appropriate rewards amount, effectively placing a hold on that portion of the user's rewards balance. A virtual account number is generated per normal and the associated credit/rewards split is recorded by the single currency rewards system. In a purchase authorization aspect of the alternative embodiment, the virtual account number is routed to the single currency rewards system per normal and a credit authorization request is issued to the credit decisioning system for the full amount of the purchase authorization request. The associated credit decision is returned in the purchase authorization response.

In a clearing and settlement aspect of the alternative embodiment, following a successful purchase authorization request/response, the merchant eventually settles the purchase via the acquiring bank and/or credit card association. The single currency rewards system receives the clearing record for the associated virtual account number, retrieves the “split” record, charges the user's credit account the full amount of the purchase, debits the user's rewards account (offsetting the previous “hold”) and subsequently issues an equivalent financial credit refund (single currency rewards refund) to the user's credit account. In a purchase refund aspect of the alternative embodiment, the merchant submits a refund request for the original purchase amount (less any fees etc.). The single currency rewards system applies a credit equal to the refund request amount to the user's credit account, then retrieves the associated “split” record, credits the rewards account with the recorded amount and reverses the associated credit refund (single currency rewards refund) applied earlier to the user's credit account.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

1. A method of using rewards currency units directly at a point of sale, comprising:
allowing a card member at a computing device to enter a selection of an option for a method of payment for a transaction with a merchant and a selection to generate a virtual account number, the payment method options consisting at least in part of payment of a purchase amount wholly with single currency reward units and payment of a portion of the purchase amount with single currency reward units and a balance of the purchase amount with a credit charge;
creating a log for the virtual account number with information consisting at least in part of the purchase amount and the selected payment method and accessing a single currency rewards database by a virtual account number engine to determine whether the card member has a sufficient balance of single currency rewards units for the payment of the purchase amount according to the selected payment method;
generating and presenting a virtual account number by the virtual account number engine for use by the card member in the transaction with the merchant, if the card member has a sufficient balance of single currency rewards units for the payment of the purchase amount according to the selected payment method;
receiving a request for authorization of the transaction with the virtual account number from the merchant;
checking the request for authorization against the log for the virtual account number to determine an amount of credit charge necessary to pay the purchase amount net of any portion of the purchase amount to be paid by single currency reward units, processing any credit charge portion of the request for authorization through a virtual account number authorization processor, and sending an authorization for the transaction to the merchant;
decrementing the card member's single currency reward account by an amount equal to any portion of the purchase amount to be paid with single currency reward units and processing an amount of a credit charge necessary to pay the purchase amount net of any portion of the purchase price paid by single currency reward units through a credit card settlement system.

2. The method of claim 1, wherein allowing the card member to enter the selections further comprises auto-popping by a virtual account number application pre-installed on the computing device when a credit card account number field at a checkout page of the merchant's website is detected by the virtual account number application.

3. The method of claim 2, wherein allowing the card member to enter the selections further comprises determining by an artificial intelligence function of the virtual account number application when the virtual account number application auto-pops whether a credit card account of the card member qualifies for a single currency rewards program and whether the merchant's website qualifies for the single currency rewards program.

4. The method of claim 3, wherein allowing the card member to enter the selections further comprises displaying for the card member a payment screen prompting entry of the selection of the option for the method of payment and the selection to generate the virtual account number, if both the card member's credit card account and the online merchant's website qualify for the single currency rewards program when the virtual account number application auto-pops.

5. The method of claim 4, wherein allowing the card member to enter the selections further comprises displaying for the card member on the payment screen a cash value of a balance of currency rewards units available to the card member for redemption at the merchant website adjusted according to a redemption rate associated with the merchant.

6. The method of claim 1, wherein generating and presenting the virtual account number further comprises prompting the card member to re-specify the card member's selection of payment method and closing the virtual account number, if the card member has an insufficient balance of single currency rewards units for the payment of the purchase amount according to the selected payment method.

7. The method of claim 1, wherein generating and presenting the virtual account number further comprises allowing the card member to present the virtual account number to the merchant for payment of the purchase amount as if it were a credit card number.

8. The method of claim 1, wherein receiving the request for authorization further comprises receiving the request for authorization by a financial institution.

9. The method of claim 1, wherein checking the request for authorization, processing any credit charge portion of the request, and sending the authorization further comprises checking the request for authorization, processing any credit charge portion of the request for authorization, and sending an authorization to the merchant by a financial institution.

10. The method of claim 1, wherein receiving the request for settlement further comprises receiving the request for settlement of the transaction from the merchant by a financial institution.

11. The method of claim 1, wherein decrementing the card member's single currency reward account further comprises communicating the amount of the portion of the purchase amount to be paid with single currency reward units to the single currency rewards database.

12. A machine-readable medium on which is encoded program code for using rewards currency units directly at a point of sale, the program code comprising instructions for:
allowing a card member at a computing device to enter a selection of an option for a method of payment for a transaction with a merchant and a selection to generate a virtual account number, the payment method options consisting at least in part of payment of a purchase amount wholly with single currency reward units and payment of a portion of the purchase amount with single currency reward units and a balance of the purchase amount with a credit charge;
creating a log for the virtual account number with information consisting at least in part of the purchase amount and the selected payment method and accessing a single currency rewards database by a virtual account number engine to determine whether the card member has a sufficient balance of single currency rewards units for the payment of the purchase amount according to the selected payment method;
generating and presenting a virtual account number by the virtual account number engine for use by the card member in the transaction with the merchant, if the card member has a sufficient balance of single currency rewards units for the payment of the purchase amount according to the selected payment method;
receiving a request for authorization of the transaction with the virtual account number from the merchant;
checking the request for authorization against the log for the virtual account number to determine an amount of credit charge necessary to pay the purchase amount net of any portion of the purchase amount to be paid by single currency reward units, processing any credit charge portion of the request for authorization through a virtual account number authorization processor, and sending an authorization for the transaction to the merchant;
receiving a request for settlement of the transaction from the merchant according to the authorization; and
decrementing the card member's single currency reward account by an amount equal to any portion of the purchase amount to be paid with single currency reward units and processing an amount of a credit charge necessary to pay the purchase amount net of any portion of the purchase price paid by single currency reward units through a credit card settlement system.

13. A computer-implemented system for using rewards currency units directly at a point of sale, comprising:
means for allowing a card member at a computing device to enter a selection of an option for a method of payment for a transaction with a merchant and a selection to generate a virtual account number, the payment method options consisting at least in part of payment of a purchase amount wholly with single currency reward units and payment of a portion of the purchase amount with single currency reward units and a balance of the purchase amount with a credit charge;
means for creating a log for the virtual account number with information consisting at least in part of the purchase amount and the selected payment method and accessing a single currency rewards database by a virtual account number engine to determine whether the card member has a sufficient balance of single currency rewards units for the payment of the purchase amount according to the selected payment method;
means for generating and presenting a virtual account number by the virtual account number engine for use by the card member in the transaction with the merchant, if the card member has a sufficient balance of single currency rewards units for the payment of the purchase amount according to the selected payment method;
means for receiving a request for authorization of the transaction with the virtual account number from the merchant;
means for checking the request for authorization against the log for the virtual account number to determine an amount of credit charge necessary to pay the purchase amount net of any portion of the purchase amount to be paid by single currency reward units, processing any credit charge portion of the request for authorization through a virtual account number authorization processor, and sending an authorization for the transaction to the merchant;
means for receiving a request for settlement of the transaction from the merchant according to the authorization; and
means for decrementing the card member's single currency reward account by an amount equal to any portion of the purchase amount to be paid with single currency reward units and processing an amount of a credit charge necessary to pay the purchase amount net of any portion of the purchase price paid by single currency reward units through a credit card settlement system.
